(19) United States
(12) Patent Application Publication
(10) Pub. No.: US 2017/0151736 A1
(43) Pub. Date: Jun. 1, 2017

(54) MODULAR METHOD OF MANUFACTURING WAVEGUIDE FOR LIGHTING SYSTEM

(71) Applicant: General Electric Company, Schenectady, NY (US)

(72) Inventors: Mark Marshall Meyers, Mechanicville, NY (US); Masako Yamada, Niskayuna, NY (US); Paul Richard Myers, Clifton Park, NY (US); Scott Michael Miller, Clifton Park, NY (US); Siavash Yazdanfar, Niskayuna, NY (US)

(21) Appl. No.: 14/955,632

(22) Filed: Dec. 1, 2015

(51) Int. Cl. B29D 11/00; F21V 8/00; B29C 45/14

(52) U.S. Cl. CPC B29D 11/00663; B29C 45/14811; G02B 6/0065; G02B 6/0038; G02B 6/0058; G02B 6/0063

(57) ABSTRACT

A modular method of manufacturing a waveguide is disclosed. The method includes positioning a mold insert including a plurality of mold prototypes, along at least one side wall of a molding equipment such that micro-optic structures of each mold prototype in the plurality of mold prototypes, faces a mold cavity. Each mold prototype extends along a length of the mold insert and the plurality of mold prototypes is disposed adjacent one another along a height of the mold insert. The method further includes feeding a material into the mold cavity for molding the material in the mold cavity to generate waveguide including a major surface having an optical pattern, where the optical pattern includes a plurality of elongated facets. Each of the plurality of elongated facets extends into the major surface and along a length of the waveguide. Further, the optical pattern extends along a height of the waveguide.

### BACKGROUND

The present technique disclosed herein generally relates to lighting systems, and more specifically, to a modular method of manufacturing waveguides for lighting systems having improved output illumination distributions.

Area lighting is typically found in places, such as, homes, office spaces, warehouses, storage areas, museums, trade centers, commercial spaces, and the like. One of the continually developing technology employed for area lighting applications is lighting systems utilizing light emitting diode (LED). LED-based lighting systems are increasingly used to replace conventional fluorescent and incandescent lighting systems. LED-based lighting systems may provide a longer operating life, high luminous efficacy, and improved manufacturability at lower costs.

The conventional LED-based lighting systems may not be optimal for all area lighting applications. For instance, an overhead LED-based lighting system typically mounted on a ceiling and configured to illuminate a number of shelves on either side of aisle of a retail store, may direct light beams to areas that are of little interest. For example, in such application the light beams may be directed to the ceiling or upper sections of building walls that are above the shelves containing objects of interest, such as products for display or sale. Further, the conventional LED-based lighting systems suffer from significant scattering and absorbent losses within a lighting fixture.

Therefore, the LED-based lighting systems may need to be customized to suit different types of area lighting applications. Further, fabrication of such customized LED-based lighting systems to suit different area lighting applications generally may require a different customized tooling. Typically, the LED-based lighting systems have low volume production, therefore fabricating such customized tooling for each area lighting application is prohibitively expensive and time consuming.

### BRIEF DESCRIPTION

In accordance with one exemplary embodiment, a modular method of manufacturing a customized waveguide for a lighting system employing Light Emitting Diodes (LEDs) for different applications is disclosed. In accordance with aspects of the present technique, the method includes positioning a mold insert including a plurality of mold prototypes, along at least one side wall of a molding equipment such that micro-optic structures of each mold prototype in the plurality of mold prototypes, faces a mold cavity, where each mold prototype extends along a length of the mold insert and where each mold prototype of the plurality of mold prototypes is disposed adjacent one another along a height of the mold insert. The method further includes feeding a material into the mold cavity for molding the material in the mold cavity to generate the waveguide including a major surface having an optical pattern, where the optical pattern includes a plurality of elongated facets, where each of the plurality of elongated facets extends into the major surface and along a length of the waveguide, and where the optical pattern extends along a height of the waveguide.

In accordance with another exemplary embodiment, a modular method of manufacturing a customized waveguide for a lighting system employing Light Emitting Diodes (LEDs) for different applications is disclosed. In accordance with aspects of the present technique, the method includes making a blue-print of a desirable optical design for the lighting system by selecting one or more pre-fabricated prototypes from a plurality of pre-fabricated prototypes. Further, the method includes separating out micro-optic structures from a corresponding pre-fabricated prototype from the plurality of pre-fabricated prototypes, to obtain a plurality of mold prototypes, where each mold insert in the plurality of mold prototypes has pre-formed micro-optic structures. The method further includes disposing the plurality of mold prototypes adjacent one another on the mold insert, in a non-interleaved manner. Further, the method includes positioning the mold insert along at least one side wall of a molding equipment such that the micro-optic structures of each mold prototype faces a mold cavity, where each mold prototype in the plurality of mold prototypes, extends along a length of the mold insert, and where each mold prototype of the plurality of mold prototypes is disposed adjacent one another along a height of the mold insert. The method further includes feeding a material into the mold cavity for molding the material in the mold cavity to generate the waveguide including a major surface having an optical pattern, where the optical pattern includes a plurality of elongated facets, where each of the plurality of elongated facets extends into the major surface and along a length of the waveguide, and where the optical pattern extends along a height of the waveguide.

### DRAWINGS

These and other features and aspects of embodiments of the present technique will become better understood when the following detailed description is read with reference to the accompanying drawings in which like characters represent like parts throughout the drawings, wherein:

FIG. 1 is a perspective view of a lighting system, in accordance with aspects of the present technique;

FIG. 2 is a block diagram of a plurality of pre-fabricated prototypes, in accordance with aspects of the present technique;

FIG. 3 is a schematic representation of a plurality of mold prototypes disposed along a mold insert, in accordance with aspects of the present technique;

FIG. 4 is a schematic representation of a cross-sectional view of a molding equipment including the mold insert of FIG. 3, in accordance with aspects of the present technique;

FIG. 5 is a perceptive view of a waveguide employed in a lighting system of FIG. 1, in accordance with aspects of the present technique;

FIG. 6 is a side view of the waveguide of FIG. 5, in accordance with aspects of the present technique;

FIG. 7 is an exemplary optical pattern of the waveguide of FIGS. 5 and 6, in accordance with aspects of the present technique;

FIG. 8 is a cross-sectional view of a lighting system, in accordance with aspects of the present technique; and

FIG. 9 is a flow diagram of an exemplary method of manufacturing a waveguide, in accordance with aspects of the present technique.

### DETAILED DESCRIPTION

Embodiments discussed herein disclose a modular method of manufacturing waveguides for lighting systems. In some embodiments, the lighting systems may employ Light Emitting Diodes (LEDs). The waveguides may be optically coupled to the LEDs. Further, the waveguides may be oriented vertically or horizontally from an overhead region, such as, a ceiling and aligned to illuminate an area of interest by directing light to targeted areas. In certain embodiments, the waveguide includes a major surface having an optical pattern which may generate output illumination distributions satisfying the need of multiple applications. The optical pattern includes a plurality of elongated facets, such as, ramp facets, prism facets, decentered cylindrical facets, spherical facets, planar horizontal facets, planar vertical facets, curved facets, and the like. The modular method of manufacturing the waveguide includes using a mold insert having a plurality of mold prototypes, where each mold prototype has pre-formed micro-optic structures. In one embodiment, the micro-optic structures in the plurality of mold prototypes may correspond to at least a portion of the optical pattern of the waveguide. In one embodiment, the plurality of mold prototypes may be obtained by selecting one or more pre-fabricated prototypes from a plurality of pre-fabricated prototypes and separating out (for example, by cutting) the one or more selected pre-fabricated prototypes. In such embodiments, selection and cutting of the one or more selected pre-fabricated prototypes from the plurality of pre-fabricated prototypes, is based on an optical design requirement of the lighting system. The plurality of mold prototypes may be disposed adjacent one another on the mold insert, in a non-interleaved manner for fabricating the waveguide with a major surface having a desired optical pattern. In some embodiments, the non-interleaved manner may include stacking the plurality of mold prototypes one above the other, where each mold prototype from the plurality of mold prototypes have a group of pre-formed micro-optic structures. Advantageously, by tailoring output illumination distributions based on pre-existing or pre-fabricated micro-optic structures of the plurality of pre-fabricated prototypes, the cost and time required to manufacture a new lighting system may be significantly reduced.

In one or more exemplary embodiments, the method of manufacturing a waveguide includes positioning a mold insert having a plurality of mold prototypes, along at least one side wall of a molding equipment such that micro-optic structures of each mold prototype in the plurality of mold prototypes, faces a mold cavity, where each mold prototype extends along a length of the mold insert and where each mold prototype of the plurality of mold prototypes is disposed adjacent one another along a height of the mold insert. The method further includes feeding a material into the mold cavity for molding the material in the mold cavity to generate the waveguide including a major surface having an optical pattern, where the optical pattern includes a plurality of elongated facets, where each of the plurality of elongated facets, extends into the major surface and along a length of the waveguide, and where the optical pattern extends along a height of the waveguide.

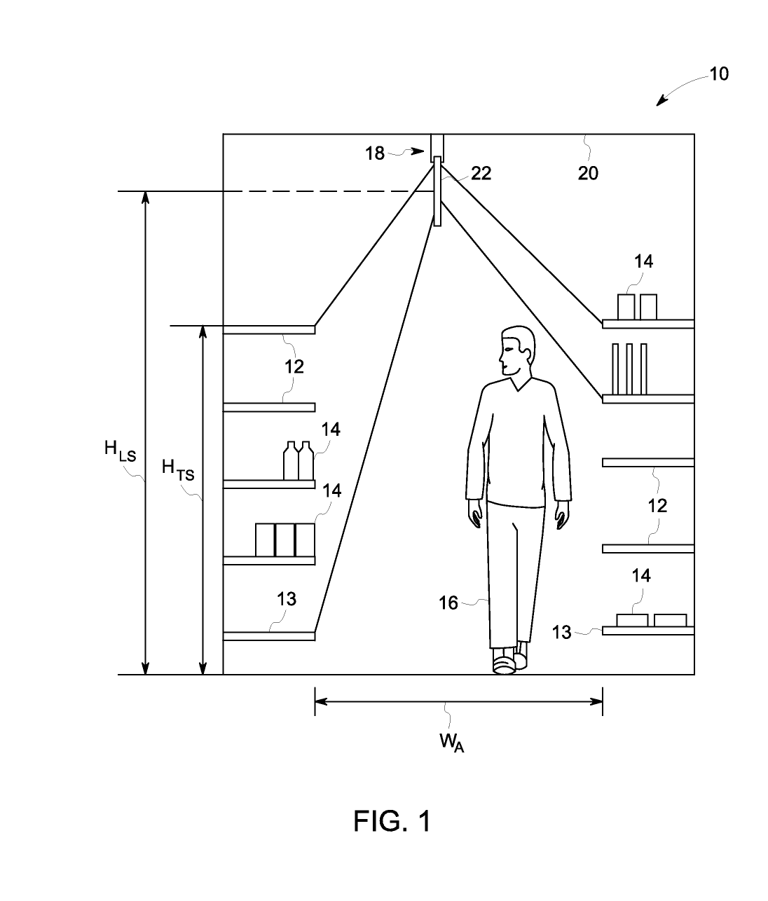

FIG. 1 illustrates an aisle 10 of a commercial space, such as, a store employing a lighting system 18 in accordance with one embodiment of the present technique. Each side of the aisle 10 includes shelves 12 13 for displaying products 14. The shelves 12, 13 are arranged such that a customer 16 is able to view the products 14 displayed on the shelves 12, 13. In some embodiments, the shelves 13 are disposed at a lower level, and hence are positioned farther from the lighting system 18 that is mounted on the ceiling 20. The aisle 10 may have an associated aisle width W_{A}. The aisle width W_{A} may be in the range of 2.0 m-4.0 m, for example. Further, the shelves 12, 13 may be arranged along a wall, such that the top shelf is positioned at a height H_{TS} above the floor. The height H_{TS} may be in the range of 1.5 m-3.0 m, for example. As will be appreciated, the aisle width W_{A} and the top shelf height H_{TS} may be greater or less than the ranges described.

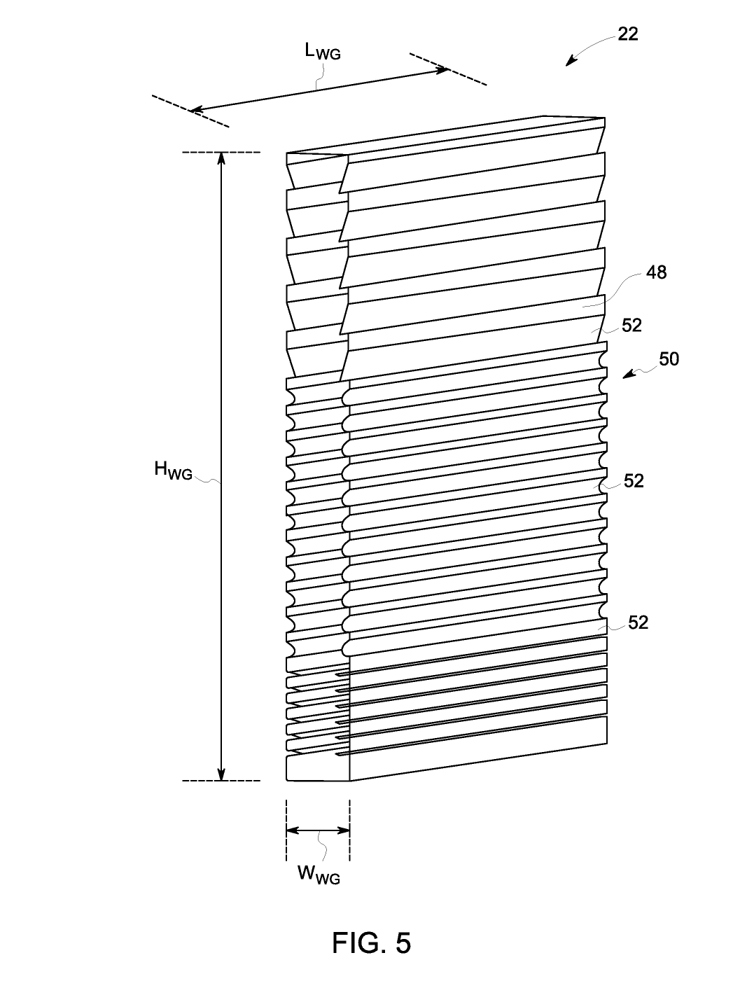

In order to illuminate the products 14 on the shelves 12, 13, a luminaire or lighting system 18 is provided. As illustrated, the lighting system 18 is mounted on a ceiling 20 above the aisle 10 at a height H_{LS}. In a non-limiting example, the height H_{LS} may be in the range of 3.0 m-9.0 m, though in some other embodiments, the height H_{LS} may be greater than or less than the range provided. In accordance with embodiments of the present technique, and as described in greater detail below, the lighting system 18 is a light emitting diode (LED)-based lighting system which includes one or more waveguides 22. In certain embodiments, the waveguide 22 is configured to illuminate the products 14 on the shelves 12, 13 in a relatively more uniform manner than many conventional lighting systems. As illustrated, the lighting system 18 is vertically oriented above the shelves 12, 13. However, in some other embodiments, the lighting system 18 may be horizontally oriented above the shelves 12, 13. The waveguide 22 is configured to direct light to both sides of the aisle 10 from a major surface 48 (as shown in FIG. 5) of the waveguide 22. The major surface 48 of the waveguide 22 is optically patterned such that the major surface 48 provides a more uniform light distribution to the shelves 13 that are disposed relatively farther from the lighting system 18. By way of example, the waveguide 22 facilitates enhanced lighting in the shelves 13. In particular, the optically patterned surfaces of the waveguide 22 are tailored such that the shelves 13 are illuminated with generally the same light intensity and distribution as the shelves 12 that are disposed relatively closer to the lighting system 18. The optically patterned major surface 48 of the waveguide 22 and a modular method of manufacturing such a waveguide 22 are discussed in greater detail below.

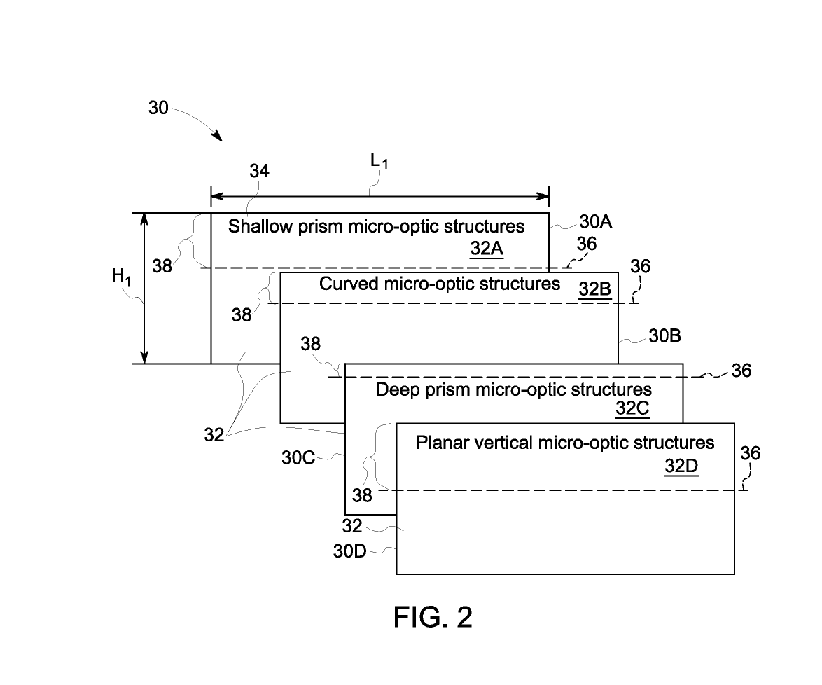

FIG. 2 is a block diagram of a plurality of pre-fabricated prototypes 30, such as, electroforms in accordance with one embodiment of the present technique. In the illustrated embodiment, each pre-fabricated prototype 30 includes micro-optic structures 32. The micro-optic structures 32 of the plurality of pre-fabricated prototypes 30 are pre-formed and stored for future use. The plurality of pre-fabricated prototypes 30 serves as a repository of a plurality of pre-formed micro-optic structures of one or more types. It may be noted that hereinafter, the terms “pre-formed micro-optic structures” and “micro-optic structures” may be used interchangeably. When a waveguide, such as the waveguide 22 of FIG. 1, needs to be manufactured, readily available pre-formed micro-optic structures 32 from the plurality of pre-fabricated prototypes 30 may be used to form the waveguide 22. In the illustrated embodiment, a first pre-fabricated prototype 30a from the plurality of pre-fabricated prototypes, may include a plurality of shallow prism micro-optic structures, represented generally by reference numeral 32a, a second pre-fabricated prototype 30b from the plurality of pre-fabricated prototypes, may include a plurality of curved micro-optic structures, represented generally by reference numeral 32b, a third pre-fabricated prototype 30c from the plurality of pre-fabricated prototypes, may include a plurality of deep prism micro-optic structures, represented generally by reference numeral 32c, and a fourth pre-fabricated prototype 30d from the plurality of pre-fabricated prototypes, may include a plurality of planar vertical micro-optic structures, represented generally by reference numeral 32d. The term “shallow prism” as used in the context may refer to a prism micro-optic structure having a tilt angle at about 8 degrees from a major surface of the first pre-fabricated prototype 30a. The term “deep prism” as used in the context may refer to a prism micro-optic structure having a tilt angle at about 55 degrees from a major surface of the third pre-fabricated prototype 32c. In some other embodiments, the plurality of pre-fabricated prototypes 30 may include ramp micro-optic structures, cylindrical micro-optic structures, planar horizontal micro-optic structures, planar vertical micro-optic structures, or combinations thereof. The micro-optic structures 32 may extend along a length “L₁” of the corresponding pre-fabricated prototype of the plurality of pre-fabricated prototypes 30. Further, the micro-optic structures 32 may be arranged in multiple rows along a height “H₁” of each pre-fabricated prototype 30. In some embodiments, the plurality of pre-fabricated prototypes 30 may be manufactured by machining, electrodeposition, lamination, or combinations thereof. In such embodiments, the plurality of pre-fabricated prototypes 30 includes a nickel material.

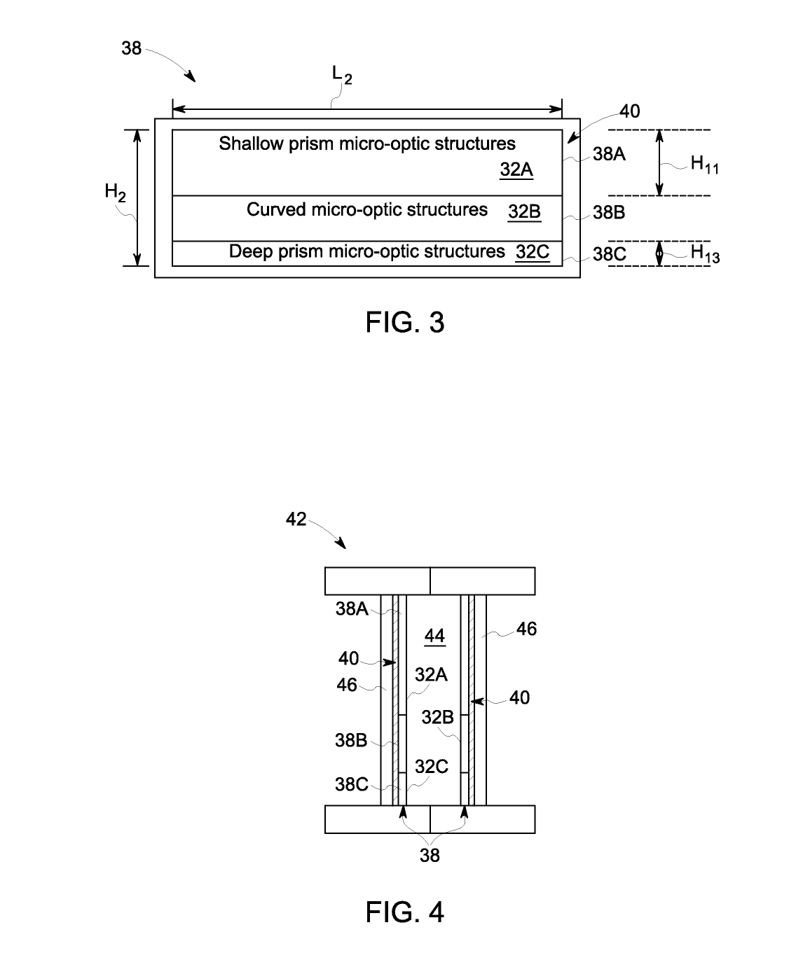

In one embodiment, one or more pre-fabricated prototypes 30 are selected based on a desired optical design of the lighting system. Further, in such embodiments, a portion of the selected pre-fabricated prototype 30 may be separated (i.e. cut) from a remaining portion of the pre-fabricated prototype 30 to form a plurality of mold prototypes 38. In the illustrated embodiment, the separated portion is represented by dotted line 36. In particular, the separated portions of the first, second, and third pre-fabricated prototypes 30a, 30b, 30c may represent the plurality of mold prototypes 38a, 38b, 38c (as shown in FIG. 3). Dimensions of the separated portion may be decided based on a desirable profile of a major surface 48 of the waveguide 22. In particular, the dimensions of each separated portion correspond to the desired optical pattern of the waveguide 22. In certain embodiments, the portion of the selected pre-fabricated prototypes 30 is cut along the determined length “L₁” and height “H₁” to form the plurality of mold prototypes 38. Further, the plurality of mold prototypes 38 is selected based on preferred output illumination distributions of the lighting system. In the illustrated embodiment, each mold prototype in the plurality of mold prototype 38 includes the pre-formed micro-optic structure 32 obtained from the corresponding pre-fabricated prototype 30.

FIG. 3 illustrates a plurality of mold prototypes 38 disposed on a mold insert 40 in accordance with one embodiment of the present technique. The plurality of mold prototypes 38 may be selected based on the preferred output illumination distributions of the lighting system. In the illustrated embodiment, three mold prototypes from the plurality of mold prototypes 38 (as shown in FIG. 2) are disposed adjacent one another. In particular, the first, second, and third mold prototypes 38a, 38b, 38c are assembled along the mold insert 40 in a non-interleaved manner. In certain embodiments, the plurality of mold prototypes 38 may be further coupled to the mold insert 40. Each mold prototype 38 may have a particular type of the micro-optic structures 32 arranged in multiple rows and columns of the corresponding mold prototype.

Each mold prototype 38 extends along a length “L₂” of the mold insert 40. Further, the plurality of mold prototypes 38 is disposed adjacent one another along a height “H₂” of the mold insert 40. In one embodiment, each mold prototype in the plurality of mold prototypes 38, has a different height, for example, the first mold prototype 38a has a first height “H₁₁” and the third mold prototype 38c has a height “H₁₃” which is different than the height “H₁₁”. As discussed earlier in the embodiment of FIG. 2, the height of each mold prototype from the plurality of mold prototypes 38 may be decided based on a desirable profile of a major surface 48 of the waveguide 22.

FIG. 4 is a schematic representation of a cross-sectional view of a molding equipment 42 including the mold inserts 40 of FIG. 3, in accordance with one embodiment of the present technique. In one embodiment, the molding equipment 42 is an injection molding equipment. The mold inserts 40 are positioned along both side walls 46 of the molding equipment 42 such that the micro-optic structures 32a, 32b, 32c of the plurality of mold prototypes 38a, 38b, 38c respectively, faces a mold cavity 44. A material (not shown in FIG. 4) is injected or poured into the mold cavity 44 and allowed to solidify in the mold cavity 44 to generate a waveguide 22 (as shown in FIG. 5). In certain embodiments, the mold insert 40 may be coupled to the side walls 46 before injecting the material. In certain embodiments, the material injected or poured into the mold cavity 44 is a molten material.

In some embodiments, the molding equipment 42 may be a compression molding equipment (also referred as “embossing equipment” or “imprinting equipment”). In such embodiments, the mold inserts 40 may be positioned along both side walls 46 of the molding equipment 42 such that the micro-optic structures 32a, 32b, 32c of the plurality of mold prototypes 38a, 38b, 38c respectively, faces the mold cavity 44. A material may be transferred into the mold cavity. Further, the material may be heated in the mold cavity 44 and pressure may be applied on the material to allow the material to cure in the mold cavity 44 to generate the waveguide 22. In certain embodiments, the material transferred into the mold cavity 44 may be a semi-solid material.

In some other embodiments, the molding equipment 42 may be reactive molding equipment. In such embodiments, the mold inserts 40 may be positioned along both side walls 46 of the molding equipment 42 such that the micro-optic structures 32a, 32b, 32c of the plurality of mold prototypes 38a, 38b, 38c respectively, faces the mold cavity 44. A material may be injected into the mold cavity. Further, the material may be allowed to expand and cure in the mold cavity 44 to generate the waveguide 22. In certain embodiments, the material injected into the mold cavity 44 may be a molten material.

The molding techniques discussed herein should not be construed as a limitation of the present technique. In one embodiment, the material and/or the molten material and/or the semi-solid material may include a plastic material, a polymer material, and a glass material. The plastic material may include acrylate or polycarbonate, for example, and the glass material may include silica or fluoride, for example.

In one embodiment, the waveguide 22 so formed includes two major surfaces having an optical pattern of a plurality of elongated facets. Although not illustrated in FIG. 4, in some embodiments, the plurality of mold prototypes 38 may be assembled along a single side wall 46 depending on the application and design criteria. In these embodiments, the waveguide 22 may include one major surface having the optical pattern of the plurality of elongated facets.

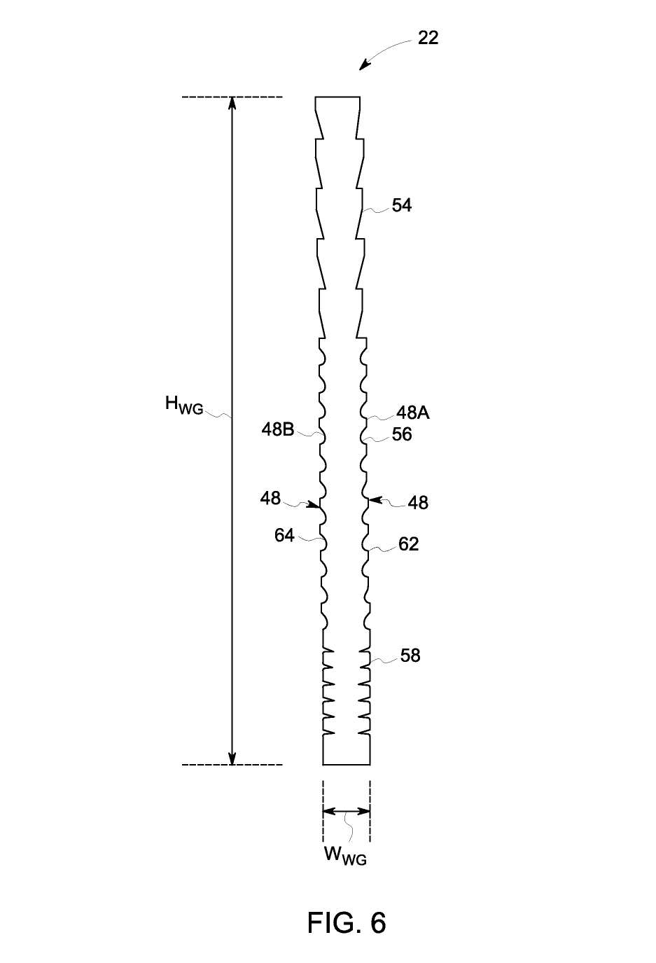

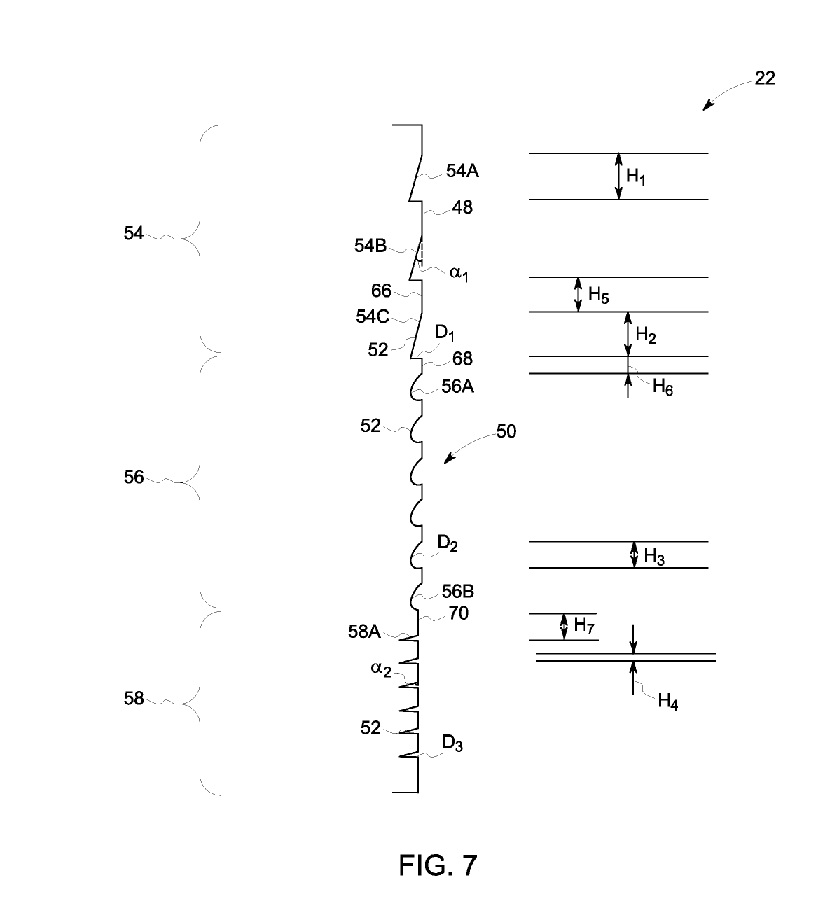

Although the embodiments of FIGS. 3 and 4 illustrate three mold prototypes 38 being used in the molding equipment 42, it should be understood that fewer or more number of mold prototypes 38 may be used to manufacture the waveguide 22, based on the desirable output illumination distributions of the lighting system. By way of example, in certain embodiments, one or more mold prototypes, for example, a mold prototype having planar vertical micro-optic structures (as shown in FIG. 2) may additionally be disposed on the mold insert 40 based on the preferred output illumination distributions of the lighting system. Thus, the present technique employs the pre-formed micro-optic structures of the plurality of mold prototypes to customize any new requirement for the lighting system and may avoid creating a separate tooling (i.e. the plurality of pre-fabricated prototypes) for every new requirement of the lighting system. The optical features of the waveguide 22 are discussed in greater detail below with respect to FIGS. 6 and 7.

Referring to FIGS. 5-6, in particular FIG. 5 is a perspective view of a waveguide 22 and FIG. 6 is a side view of the waveguide 22 in accordance with one embodiment of the present technique. In one embodiment, the waveguide 22 disclosed hereinafter is manufactured using the techniques discussed above. The waveguide 22 includes major surfaces 48 configured for providing desirable optical output intensity distribution to the surrounding environment. The waveguide 22 includes a length L_{WG}, a height H_{WG}, and a width W_{WG}. As used hereinafter, the length L_{WG} may refer to the horizontal dimension of the waveguide 22 as it extends in the length parallel to a surface above, such as the ceiling 20 (as shown in FIG. 1). The height H_{WG} of the waveguide 22 may refer to the vertical dimension of the waveguide 22 as the height H_{WG} extends in the direction perpendicular to the surface above, such as the ceiling 20. The width W_{WG} may refer to the thickness of the waveguide 22 and is the shortest dimension of the waveguide 22.

The length L_{WG} of the waveguide 22 may be any desirable length, depending on the strength of a light source (not shown), the manufacturing capabilities for the production of the waveguide 22, and the application in which the lighting system 18 (as shown in FIG. 1) is employed. In one embodiment, the length L_{WG} may be the longest dimension of the waveguide 22, while in some other embodiment, the height H_{WG} may be the longest dimension of the waveguide 22. In one embodiment, the length L_{WG} of the waveguide 22 may be in the range of 0.5-0.75 meters, such as, 0.61 meters. In one embodiment, the height H_{WG} of the waveguide 22 may be in the range of 0.10-0.20 meters, such as, 0.128 meters. Comparatively, the width W_{WG} of the waveguide 22 is relatively small. For instance in one embodiment the width W_{WG}, of the waveguide 22 maybe in the range of 0.003-0.005 meters, such as, 0.004 meters.

The waveguide 22 includes major surfaces 48, for example, a first major surface 48a on a first side 62 of the waveguide 22 and a second major surface 48b on a second side 64 of the waveguide 22. The first and second sides 62, 64 are positioned opposite to one another. As previously described, each major surface 48 is fabricated to direct light in a downward manner such that a desired region is illuminated in a uniform manner throughout its entire verticality (e.g. shelves 12, 13 arranged along a wall of an aisle 10, as depicted in FIG. 1).

In accordance with embodiments described herein, the waveguide 22 has been optimized by creating an optical pattern 50 of a plurality of elongated facets 52 on each major surface 48. In the illustrated embodiment, the optical pattern 50 formed in the first major surface 48a is a mirror image of the optical pattern 50 formed in the second major surface 48b. In one or more embodiments, the plurality of elongated facets 52 penetrate into each major surface 48 of the waveguide 22 such that the optical pattern 50 spoils total internal reflections that would have occurred with a smooth or un-patterned surface of the waveguide 22. Each of the plurality of elongated facets 52 extends into the major surface 48 at a depth of less than 0.10 millimeters. The optical pattern 50 extends along the height H_{WG} of the waveguide 22 and each of the plurality of elongate facets 52 extends into the width “W_{WG}” of the major surface 48 and along the entire length L_{WG} of the waveguide 22.

In one embodiment, the plurality of elongated facets includes: 1) shallow prism facets 54, 2) curved facets, 56, and 3) deep prism facets 58. In some other embodiments, the major surface 48 may include other types of facets, such as, ramp facets, cylindrical facets, planar horizontal facets, and planar vertical facets, depending on the application and design criteria. In the illustrated embodiment of FIGS. 5 and 6, each of the plurality of elongated facets 52 is grouped together, for example, a group of shallow prism facets 54 are disposed above a group of curved facets 56 on the major surface 48. In one or more embodiments, the plurality of elongated facets 52 is disposed in a non-interleaving manner on the waveguide 22.

FIG. 7 illustrates the waveguide 22 having an optical pattern 50 of a plurality of elongated facets 52 in accordance with an embodiment of the present technique. The plurality of elongated facets 52 includes shallow prism facets, generally depicted by reference numeral 54, curved facets, generally depicted by reference numeral 56, and deep prism facets, generally depicted by reference numeral 58. In one embodiment, each of the different type of facets 54, 56, 58 are grouped together and disposed on the major surface 48 in a non-interleaved manner. For example, in the illustrated embodiment, the optical pattern 50 includes three shallow prism facets 54 which are grouped together and disposed at top portion of the waveguide 22. Further, the optical pattern 50 includes six curved facets 56 which are grouped together and disposed at middle portion of the waveguide 22. Finally, the optical pattern 50 includes six deep prism facets 58 which are grouped together and disposed at bottom portion of the waveguide 22. In particular, each such group is disposed adjacent to each other on the major surface 48 in non-interleaved manner.

Each shallow prism facet 54 includes one or more geometric features required for providing a desirable optical output illumination distribution of the surrounding environment. The geometric features include tilt angle, height, width, depth of cut, length, center to center distance, zone width, and the like. In the illustrated embodiment, the first shallow prism facet 54a has a height “H₁” and the third shallow prism facet 54c has a height “H₂” different than the height “H₁”. The height “H₁” or “H₂” is in a range from about 0.9 mm to 1.2 mm, the tilt angle “α₁” is about 8 degrees, depth of cut “D₁” is about 0.038 mm, center to center distance (not shown) is about 1 mm, and the zone width (not shown) is about 43 mm Each curved facet 56 has a height “H₃” in a range from about 0.5 mm to about 0.9 mm and a depth of cut “D₂” of about 0.038 mm Similarly, the deep prism facet 54 has a height “H₄” in a range from about 0.3 mm to 0.4 mm, the tilt angle “α₂” is about 55 degrees, depth of cut “D₃” is about 0.1 mm, center to center distance (not shown) is about 1 mm, and the zone width (not shown) is about 31 mm. Further, each facet in the plurality of elongated facets 52 may be separated by a planar vertical facet. For example, the second shallow prism 54b and the third shallow prism facets 54c are separated by a planar vertical facet 66, which may have a height “H₅” of about 0.6 mm Similarly, the third shallow prism facet 54c and a first curved facet 56a are separated by a planar vertical facet 68, which may have a height “H₆” of about 0.3 mm and a last curved facet 56b and a first deep prism facet 58a are separated by a planar vertical facet 70, which may have a height “H₇” of about 0.5 mm The planar vertical facets may represent planar portions of the major surface 48 of the waveguide 22 that remain planar and un-patterned and disposed perpendicular to the ceiling or floor. It should be noted that the optical pattern 50 shown in FIG. 7 is not drawn to scale. That is, angles, lengths, widths and radii of curvature may be exaggerated in order to more clearly illustrate the depicted features.

Although not illustrated in FIG. 7, in some embodiments, the optical pattern 50 may include ramp facets which may extend into major surface 48 of the waveguide 22 at a pre-defined angle as measured from the major surface 48 of the waveguide 22. The pre-defined angle may be about 2.45 degrees to about 4.1 degrees. In addition, the ramp facets may have a vertical distance (i.e. height of each facet) of about 0.70 mm. Further, the optical pattern 50 may include cylindrical facets, where the radius of curvature of the cylindrical facet may be about 1.75 mm Further, the vertical distance of the cylindrical facet may be about 0.2 mm. The optical pattern 50 may further include planar horizontal facets, which are arranged parallel to the horizontal surfaces of the ceiling and floor when the lighting system 18 is installed for overhead illumination, as described with regard to FIG. 1. The planar horizontal facets may have a horizontal length of about 0.03 mm and may extend 0.03 mm to about 0.005 mm into the major surface 48 of the waveguide 22. Each of the ramp facets, cylindrical facets, and planar horizontal facets may be grouped together in a non-interleaving manner on the major surface 48 of the waveguide 22.

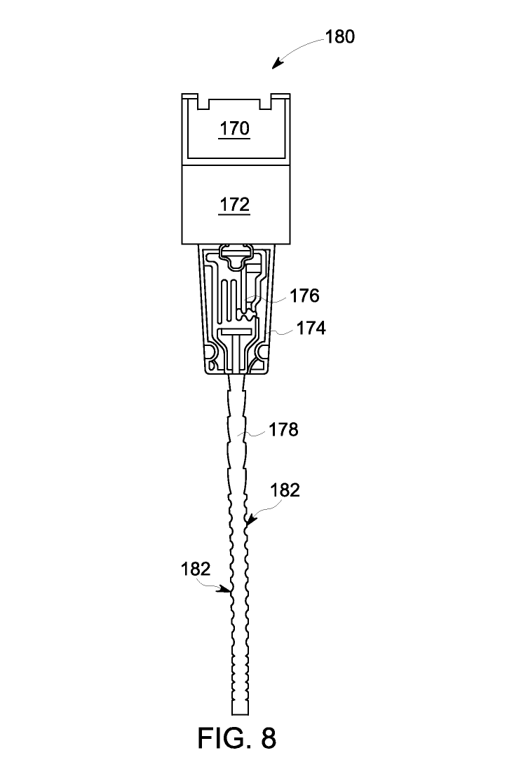

FIG. 8 illustrates a cross-sectional view of a lighting system 180 in accordance with one embodiment of the present technique. The lighting system 180 includes a mounting mechanism 170 that may be used to couple the lighting system 180 to an overhead region such as a ceiling 20 (as shown in FIG. 1). The mounting mechanism 170 may be coupled directly to an electrical box 172 configured to provide mechanical support and electrical signals to a light source 174. The light source 174 may include a plurality of LED 176 (light emitting diode) that may be arranged along the length of the lighting system 180. The LED 176 is sized and configured to provide light to a waveguide 178 which may be optically coupled to the light source 174. Specifically, the light source 174 provides illumination in a downward direction into the waveguide 178. The waveguide 178 may be similar to the waveguides discussed in the embodiments of FIGS. 5, 6, and 7. As described further below, each major surface 182 of the waveguide 178 is optimally manufactured to reduce light scattering and increase overall uniformity of light distribution by directing increased light to target regions, such as the shelves 12, 13 (FIG. 1). In one embodiment, the lighting system 180 may employ one or more waveguides 178, aligned end-to-end to produce a total length of 1.5-2.25 meters, for example.

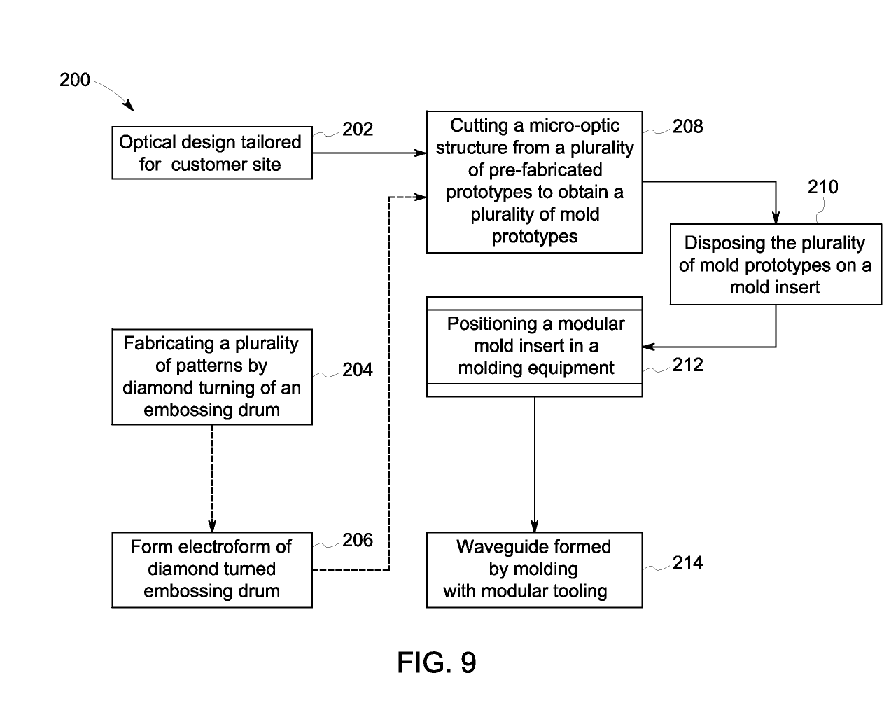

FIG. 9 is a flow diagram of a method 200 for manufacturing a waveguide in accordance with one embodiment of the present technique. The method 200 includes a step 202 of providing a desirable optical design for a lighting system based on a customer requirement. The step 202 of making the desirable optical design may include designing a theoretical model of the waveguide based on pre-existing knowledge. The theoretical model may include selecting one or more pre-fabricated prototypes from a plurality of pre-fabricated prototypes required for manufacturing the desirable optical design of the waveguide. The theoretical model may further include determining a proper height and length of each selected pre-fabricated prototype from the plurality of mold prototypes for manufacturing the waveguide.

The method 200 further includes the step 208 of separating out (for example, by cutting) micro-optic structures from the selected plurality of pre-fabricated prototypes to obtain a plurality of mold prototypes. In certain embodiments, the plurality of mold prototypes may be pre-formed and stored for later use as described with respect to non-limiting examples represented by steps 204-206. Pre-forming the plurality of mold prototypes facilitates the modular approach for the method 200. The method 200 further includes the step 210 of disposing the plurality of mold prototypes adjacent one another in a non-interleaved manner to obtain a mold insert used in manufacturing the waveguide. Various different waveguides may be formed by selecting different combinations of pre-formed micro-optic structures to form different mold inserts. The mold insert may have different combination of a pre-formed micro-optic structure, height, and length which are derived from the corresponding pre-fabricated prototype.

The method 200 includes the step 212 of positioning mold inserts within a molding equipment. Specifically, the positioning of the plurality of mold inserts within the molding equipment includes disposing the mold inserts along at least one side wall of the molding equipment such that the micro-optic structures of the plurality of mold prototypes faces a mold cavity.

The method 200 includes the step 214 of feeding a material into the mold cavity for molding the material in the mold cavity to generate a new waveguide. At least one molding technique discussed in the embodiment of FIG. 4 may be used to generate the new waveguide. In certain embodiments, the new waveguide may include a major surface having an optical pattern of a plurality of elongated facets. The optical pattern extends along a height of the waveguide and each of the plurality of elongated facets extends into the major surface and along a length of the waveguide.

The method may further include the step 204 of fabricating a plurality of patterns on a surface of an embossing drum based on the customer requirement. In certain embodiments, the plurality of patterns is fabricated by a diamond turning or a fly cutting process. In one or more embodiments, the plurality of patterns may include ramp patterns, cylindrical patterns, planar horizontal patterns, planar vertical patterns, curved patterns, prisms patterns or combinations thereof. Each pattern in the plurality of patterns may include various geometrical features, for example a prism pattern may include: width, height, length, depth of cut, zone width, tilt angle, center to center distance, and the like, which may be essential to generate desired output illumination distributions. In certain embodiments, the embossing drum may include combination of various patterns in the plurality of patterns which may meet the optical design requirement of multiple customers.

Further, the method may include the step 206 of forming a plurality of pre-fabricated prototypes. In some embodiments, the plurality of pre-fabricated prototypes may be manufactured by machining, electrodeposition, lamination, or combinations thereof. In one embodiment, the plurality of pre-fabricated prototypes includes electroforms, which is manufactured using electroplating technique. In such embodiments, a material is deposited over the plurality of patterns formed on the surface of an embossing drum. The plurality of electroforms may later be removed from the embossing drum and flattened in a form of a strip. In one or more embodiments, the plurality of electroforms may include a nickel material. The plurality of electroforms may include micro-optic structures on at least one surface. In one embodiment, the micro-optic structures may obtain all geometric features of the plurality of patterns. For example, a prism shaped micro-optic structures may obtain the geometric features, such as, width, height, length, depth of cut, zone width, tilt angle, center to center distance, and the like. In certain embodiments, the electroform may include different micro-optic structures or a combination of different micro-optic structures depending on the plurality of patterns used for manufacturing the plurality of electroforms. In one or more embodiments, one or more pre-fabricated prototypes from the plurality of pre-fabricated prototypes may be selected to form the plurality of mold prototypes required for manufacturing the new waveguide.

In accordance with one or more embodiments discussed herein, a modular method of manufacturing a waveguide includes customizing an optical pattern on a surface of the waveguide, so as to effectively direct light source to surrounding areas. The micro-optic structures required to customize the optical pattern may be selected from a same tooling, such as, a plurality of pre-fabricated prototypes. Such a process may reduce the tooling costs and time required for manufacturing different customized waveguides. Thus, lowering the tooling costs may further allow the customized design to be sold at a competitive cost, even at low volumes. Further, such a customized waveguide may efficiently distribute light to the surrounding areas, and thereby help in decreasing electricity consumption by the lighting system.

While only certain features of embodiments have been illustrated and described herein, many modifications and changes will occur to those skilled in the art. It is, therefore, to be understood that the appended claims are intended to cover all such modifications and changes as falling within the spirit of the invention.

1. A method comprising:
positioning a mold insert comprising a plurality of mold prototypes, along at least one side wall of a molding equipment such that micro-optic structures of each mold prototype in the plurality of mold prototypes, faces a mold cavity, wherein each mold prototype extends along a length of the mold insert, and wherein each mold prototype of the plurality of mold prototypes is disposed adjacent one another along a height of the mold insert; and
feeding a material into the mold cavity for molding the material in the mold cavity to generate a waveguide comprising a major surface having an optical pattern, wherein the optical pattern comprises a plurality of elongated facets, wherein each of the plurality of elongated facets extends into the major surface and along a length of the waveguide, and wherein the optical pattern extends along a height of the waveguide.

2. The method of claim 1, further comprising obtaining the mold insert, wherein obtaining the mold insert comprises:
selecting the plurality of mold prototypes from a plurality of pre-fabricated prototypes; and
disposing the plurality of mold prototypes adjacent one another on the mold insert.

3. The method of claim 2, wherein selecting the plurality of mold prototypes from the plurality of pre-fabricated prototypes comprises separating micro-optic structures from a corresponding pre-fabricated prototype based on a desired optical pattern of the waveguide.

4. The method of claim 2, wherein the plurality of pre-fabricated prototypes is formed by machining, electrodeposition, lamination, or combinations thereof.

5. The method of claim 4, wherein the electrodeposition comprises electroplating a material on a plurality of patterns fabricated on a surface of an embossing drum.

6. The method of claim 2, wherein the plurality of pre-fabricated prototypes comprises a nickel material.

7. The method of claim 1, wherein feeding a material comprises:
injecting or pouring a molten material into the mold cavity; and
allowing the molten material to solidify in the mold cavity to generate the waveguide.

8. The method of claim 1, wherein feeding a material comprises:
transferring the material into the mold cavity;
heating the material within the mold cavity; and
applying pressure on the material to allow the material to cure in the mold cavity to generate the waveguide.

9. The method of claim 1, wherein feeding a material comprises:
injecting a molten material into the mold cavity; and
allowing the molten material to expand and cure in the mold cavity to generate the waveguide.

10. The method of claim 1, wherein the plurality of mold prototypes comprises ramp micro-optic structures, cylindrical micro-optic structures, planar horizontal micro-optic structures, planar vertical micro-optic structures, curved micro-optic structures, and prism micro-optic structures.

11. The method of claim 10, wherein the plurality of elongated facets comprises ramp facets, cylindrical facets, planar horizontal facets, planar vertical facets, curved facets, prism facets, or combinations thereof.

12. The method of claim 1, wherein one or more of the plurality of mold prototypes, comprises a height that is different from a height of one or more other plurality of mold prototypes.

13. The method of claim 12, wherein each of the plurality of elongated facets comprises a different height.

14. The method of claim 1, wherein the major surface comprises a first major surface on a first side of the waveguide and a second major surface on a second side of the waveguide opposite the first major surface, and wherein the second major surface is a mirror image of the first major surface.

15. The method of claim 1, wherein the material comprises a plastic material, a polymer material, and a glass material.

16. A method comprising:
making a blue-print of a desirable optical design for a lighting system by selecting one or more pre-fabricated prototypes from a plurality of pre-fabricated prototypes;
separating out micro-optic structures from a corresponding pre-fabricated prototype from the plurality of pre-fabricated prototypes, to obtain a plurality of mold prototypes, wherein each mold prototype in the plurality of mold prototypes, comprises pre-formed micro-optic structures;
disposing the plurality of mold prototypes adjacent one another on a mold insert, in a non-interleaved manner;
positioning the mold insert along at least one side wall of a molding equipment such that micro-optic structures of each mold prototype faces a mold cavity, wherein each mold prototype in the plurality of mold prototypes, extends along a length of the mold insert, and wherein each mold prototype of the plurality of mold prototypes is disposed adjacent one another along a height of the mold insert;
and feeding a material into the mold cavity for molding the material in the mold cavity to generate a waveguide comprising a major surface having an optical pattern, wherein the optical pattern comprises a plurality of elongated facets, wherein each of the plurality of elongated facets extends into the major surface and along a length of the waveguide, and wherein the optical pattern extends along a height of the waveguide.

17. The method of claim 16, wherein the plurality of pre-fabricated prototypes is formed by machining, electrodeposition, lamination, or combinations thereof.

18. The method of claim 17, wherein the electrodeposition comprises electroplating a material on a plurality of patterns fabricated on a surface of an embossing drum.

19. The method of claim 16, wherein feeding a material comprises:
injecting or pouring a molten material into the mold cavity; and
allowing the molten material to solidify in the mold cavity to generate the waveguide.

20. The method of claim 16, wherein feeding a material comprises:
transferring the material into the mold cavity;
heating the material within the mold cavity; and
applying pressure on the material to allow the material to cure in the mold cavity to generate the waveguide.

21. The method of claim 16, wherein feeding a material comprises:
injecting a molten material into the mold cavity; and
allowing the molten material to expand and cure in the mold cavity to generate the waveguide.

22. The method of claim 16, wherein the plurality of mold prototypes comprises ramp micro-optic structures, cylindrical micro-optic structures, planar horizontal micro-optic structures, planar vertical micro-optic structures, curved micro-optic structures, and prism micro-optic structures.

23. The method of claim 22, wherein the plurality of elongated facets comprises ramp facets, cylindrical facets, planar horizontal facets, planar vertical facets, curved facets, and prism facets.
